(19) United States
(12) Patent Application Publication
(10) Pub. No.: US 2025/0226122 A1
(43) Pub. Date: Jul. 10, 2025

(54) Core Component Rodlet for Irradiating Isotope Targets in Pressurized Water Reactor Conditions

(71) Applicant: Westinghouse Electric Company LLC, Cranberry Township, PA (US)

(72) Inventors: Lisa M. DUDAS, Columbia, SC (US); Robert J. FETTERMAN, Gibsonia, PA (US); Carter E. LUNDE, Columbia, SC (US); Osama ELKADIM, Hopkins, SC (US); Alireza MOFIDI, Irmo, SC (US); Cory D. HILDEBRAND, Mount Pleasant, PA (US)

(73) Assignee: Westinghouse Electric Company LLC, Cranberry Township, PA (US)

(21) Appl. No.: 18/403,870

(22) Filed: Jan. 4, 2024

(51) Int. Cl. G21C 3/326; G21C 3/322; G21C 3/33

(52) U.S. Cl. CPC G21C 3/326; G21C 3/3225; G21C 3/33

(57) ABSTRACT

A rodlet for insertion into a fuel assembly guide tube of a fuel assembly in a pressurized water nuclear reactor is disclosed. The rodlet includes a capsule for housing a material to be irradiated, a backfill region disposed between the capsule and the material, and an outer tube comprising a plurality of apertures defined therein. The capsule defines a wall that surrounds the material. The outer tube is to house the capsule. The outer tube defines a first annulus and a second annulus. The first annulus includes a first width defined between the capsule and the outer tube. The second annulus includes a second width defined between the outer tube and the fuel assembly guide tube.

### FIELD

The present disclosure is generally related to nuclear power and, more particularly, is directed toward a core component assembly having a rodlet including a capsule of material to be irradiated when the core component assembly is positioned in a fuel assembly of a nuclear reactor during operation.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a rodlet for insertion into a fuel assembly guide tube of a fuel assembly in a pressurized water nuclear reactor is disclosed. The rodlet comprises a capsule for housing a material to be irradiated, a backfill region disposed between the capsule and the material, and an outer tube comprising a plurality of apertures defined therein. The capsule defines a wall that surrounds the material. The outer tube is to house the capsule. The outer tube defines a first annulus and a second annulus. The first annulus comprises a first width defined between the capsule and the outer tube. The second annulus comprises a second width defined between the outer tube and the fuel assembly guide tube.

In at least one aspect, the material has a first radial diameter. In at least one aspect, a radial thickness of the wall of the capsule is 0.05 to 0.10 times the first radial diameter of the material. In at least one aspect, the first width is 0.65 to 0.85 times greater than the second width. In at least one aspect, a diameter of each of the plurality of apertures is two to six times the first width. In at least one aspect, the material is 0.2 to 0.3 inches in diameter. In at least one aspect, the capsule comprises a material with a yield strength of between 60 kilopound per square inch (KSI) and 90 KSI. In at least one aspect, the outer tube comprises a material with a neutron cross section less than or equal to 0.3 barns. In at least one aspect, the outer tube comprises a material with a neutron cross section greater than or equal to 0.2 barns and less than or equal to 0.3 barns. In at least one aspect, the rodlet further comprises an end plug at an end of the outer tube and a spacer disposed between the end plug and the capsule to position the capsule at a desired axial location relative to the fuel assembly. In at least one aspect, a top end and a bottom end of the outer tube are sealed. In at least one aspect, the outer tube houses a plurality of capsules in a stacked configuration. In at least one aspect, the apertures allow coolant to flow through the apertures to cool the capsule and equalize pressure on either side of the outer tube. In at least one aspect, the backfill region is filled with air and/or helium. In at least one aspect, the material is cobalt 59. In at least one aspect, the capsule comprises one of SS304, Alloy 718, or Alloy 625. In at least one aspect, the outer tube comprises zirconium alloy. In at least one aspect, the plurality of apertures is disposed radially about the outer tube and at different vertical elevations. In at least one aspect, the plurality of apertures is greater than or equal to 4 and less than or equal to 20.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 is a perspective view of a nuclear reactor;

FIG. 2 is a perspective view of a core component assembly;

FIG. 3 is a perspective view of the core component assembly of FIG. 2 installed into a fuel assembly of the nuclear reactor of FIG. 1;

FIG. 4 is a cross section plan view of four fuel assemblies of the nuclear reactor of FIG. 1, illustrating a core component assembly positioned within two of the fuel assemblies;

FIG. 5 is a cross section view of a rodlet of a core component assembly positioned within a fuel assembly thimble guide tube of a fuel assembly of a nuclear reactor; and

FIG. 6 is a cross section elevation view of the rodlet and fuel assembly guide tube of FIG. 5.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward,” “rearward,” “left,” “right,” “upwardly,” “downwardly,” and the like are words of convenience and are not to be construed as limiting terms.

In the following description, reference characters designate like or corresponding parts throughout the several views of the drawings. Also in the following description, it is to be understood that such terms as “forward,” “rearward,” “left,” “right,” “upwardly,” “downwardly,” and the like are words of convenience and are not to be construed as limiting terms.

Before explaining various aspects of the core component rodlet in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

In general, various radioisotopes can be used for medical treatments, food sterilization and other processes requiring an alpha, beta, and/or gamma radiation source. Radioisotopes are produced by irradiating targets made of naturally occurring elements within a neutron flux. For industrial scale production of radioisotopes, irradiation of targets is currently performed in certain types of nuclear reactors where the neutron moderation and primary cooling systems are separate, such as CANDUs (e.g., heavy water moderated, light water cooled) and RBMKs (i.e., graphite moderated, light water cooled). However, increased demand for certain radioisotopes and the closure of some CANDUs and RMBKs have driven source suppliers to seek out irradiation of targets in the more common PWRs (e.g., pressurized water reactors) where the moderator and coolant are the same light water circuit.

In at least one aspect, in order to irradiate targets in a PWR, the targets are sealed within a set of capsules which are then placed into a group of core component rodlets or tubes, attached to a core component baseplate of a core component assembly, and inserted into the guide thimbles of a fuel assembly. After irradiation, the capsules containing the irradiated targets are removed from the core component rodlets and sent to a radiation source manufacturer. The source manufacturer then removes the irradiated targets from these capsules for further processing and shipment to the end-user.

Further to the above, because PWR irradiation exposes the target bearing capsules and core component assemblies to much higher operating temperatures and pressures than found in CANDUs or RBMKs, a PWR-specific target irradiation design is required. PWR-specific problems that need to be addressed for a successful irradiation strategy are the temperature and pressure induced creep of the capsules containing the targets, hydriding of the capsules and the core component tube holding the capsule stack within the fuel assembly guide tube, and boiling of the coolant in contact with the capsules, the core component tube, and the fuel assembly guide tube where the core component is installed. In addition, the PWR-specific design should seek to minimize parasitic neutron absorption by the support materials to maximize the amount of target material activation. The PWR-specific irradiated target producing core component which solves these problems is discussed in greater detail below.

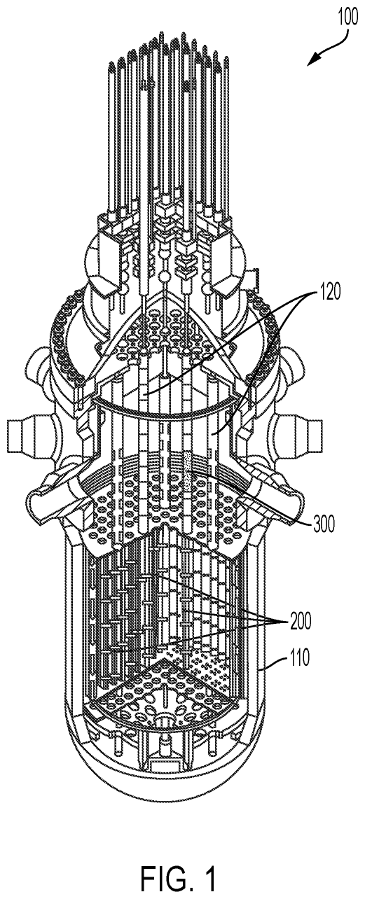

FIG. 1 illustrates a nuclear reactor 100 comprising a reactor vessel 110 including a plurality of fuel assemblies 200 positioned therein. A limited number of the fuel assemblies 200 are shown in FIG. 1 for illustrative purposes. The nuclear reactor 100 further comprises a plurality of core component guide tubes 120 above each of the fuel assemblies 200, and a plurality of core component assemblies 300 movable within the core component guide tubes 120. FIG. 1. Illustrates only one of the core component assemblies 300, however it should be understood that any number of core component assemblies 300 are movable through the core component guide tubes 120 for installation into the fuel assemblies 200. Further, the core component assemblies 300 may be of various types and designs depending on the fuel assembly type and/or region of the nuclear reactor 100 in which the core component assemblies 300 are required to be placed based on the design of the nuclear reactor 100. For example, one of the core component assemblies 300 for one of the fuel assemblies 200 may comprise a control rod core component assembly (e.g., poison control rods) and another one of the core component assemblies 300 placed in a different fuel assembly of the fuel assemblies 200 may be a moderator core component assembly such as a WABA (e.g., wet annular burnable absorber) core component assembly. In some instances, one or more of the fuel assemblies 200 may not have one of the core component assemblies 300 positioned therein based on the design of the nuclear reactor 100. Further, one or more of the core component assemblies 300 may be a COBA (e.g., cobalt burnable absorber) core component assembly, as discussed in greater detail below.

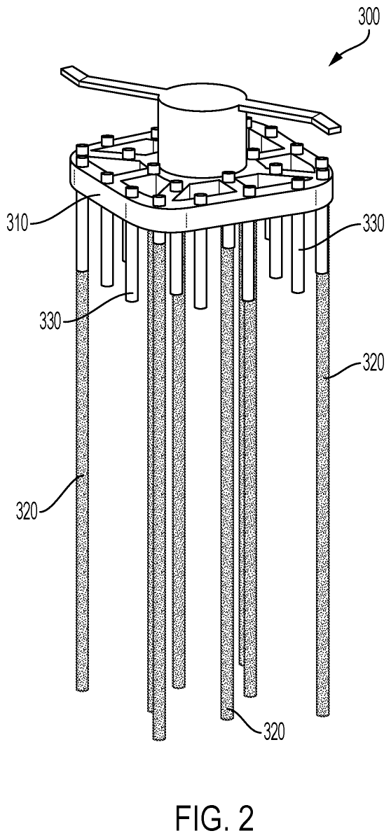

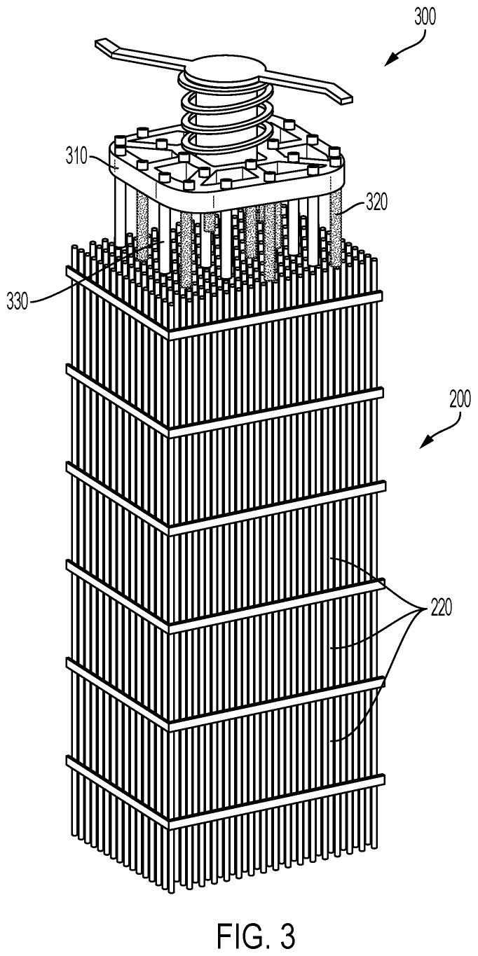

Further to the above, FIG. 2 illustrates a perspective view of one of the core component assemblies 300. In general, a typical core component assembly 300 comprises a baseplate 310 and a plurality of rodlets 320 attached to the baseplate 310. In at least one aspect, the core component assemblies 300 comprise a plurality of thimble guide tube plugs 330 that are also attached to the baseplate 310. FIG. 3 illustrates the core component assembly 300 of FIG. 2 installed into one of the fuel assemblies 200 of FIG. 1.

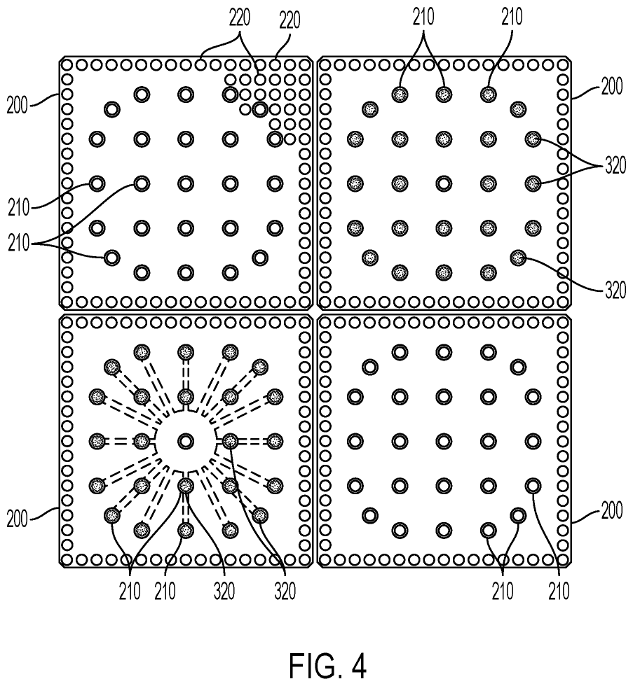

Further to the above, FIG. 4 illustrates a cross section view of a quadrant of the fuel assemblies 200 of the nuclear reactor 100 of FIG. 1. Each of the fuel assemblies 200 comprises a plurality of thimble guide tubes 210 and a plurality of fuel rods 220. When one of the core component assemblies 300 is inserted into one of the fuel assemblies 200 as shown in FIG. 3, the rodlets 320 and/or the thimble guide tube plugs 330 of the core component assembly 300 are positioned within respective thimble guide tubes 210 of the fuel assembly 200. Referring again to FIG. 4, the fuel assemblies 200 located in the upper left and bottom right do not have one of the core component assemblies 300 installed therein and the fuel assemblies 200 located in the upper right and bottom left have one of the core component assemblies 300 installed therein. Specifically, the rodlets 320 of the core component assemblies 300 are visible in the fuel assemblies 200 located in the upper right and bottom left of FIG. 4.

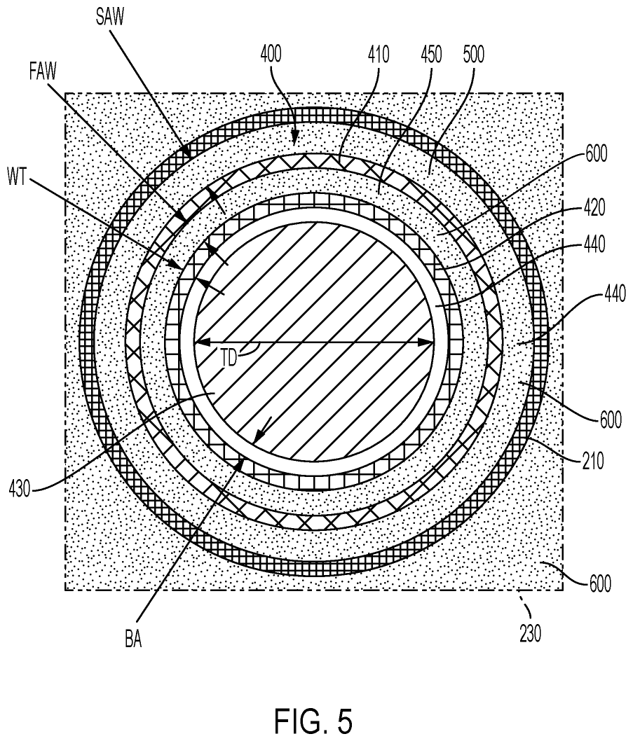

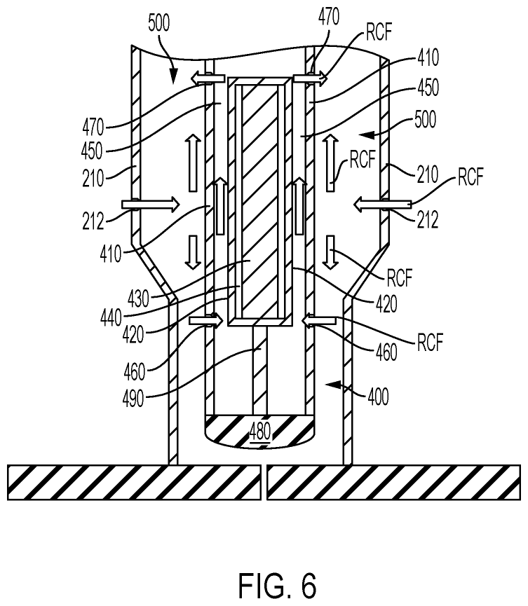

Referring now to FIGS. 5 and 6, a rodlet 400 for use with the core component assembly 300 is positioned within the thimble guide tube 210 of one of the fuel assemblies 200. In various aspects, the rodlet 400 is attachable to the baseplate 310 of the core component assembly 300, for example. It should be understood that more than one rodlet 400 may be attached to the baseplate 310 along with one or more than one thimble guide tube plugs 330 to form the core component assembly 300.

Referring still to FIGS. 5 and 6, the rodlet 400 and thimble guide tube 210 are positioned within a fuel assembly structural grid cell 230 of the fuel assembly 200. The rodlet 400 comprises a core component outer tube 410 and a capsule, or capsule tube 420, positioned within the core component outer tube 410. The capsule tube 420 is configured to house a target material 430 to be irradiated. The rodlet 400 further comprises a bottom end plug 480 and a spacer 490 (see FIG. 6). The bottom end plug 480 seals the bottom end of the core component outer tube 410. In at least one aspect, the top end of the core component outer tube 410 is sealed. In any event, the spacer 490 is configured to axially position the capsule tube 420 and, thus, the target material 430, relative to the core component outer tube 410. As such, the spacer 490 aids in positioning the target material 430 at a desired axial location within the fuel assembly 200 when the rodlet 400 is installed into the thimble guide tube 210 of the fuel assembly 200.

Further to the above, the capsule tube 420 surrounds the target material 430 to fully encapsulate the target material 430. One or more than one target material 430 may be positioned within the capsule tube 420. In at least one aspect, the capsule tube 420 defines a wall having a radial wall thickness WT (see FIG. 5). Further, the target material 430 comprises a target diameter TD as shown in FIG. 5. In at least one aspect, the target material 430 comprises Cobalt. In at least one aspect, the target material 430 comprises Cobalt 59. In at least one aspect, the target material comprises Thorium. In at least one aspect, the target material comprise Strontium. In at least one aspect, one or more than one of Cobalt, Cobalt 59, Thorium, or Strontium may be placed into the capsule tube 420. In at least one aspect, the target material 430 comprises a material that once irradiated turns into one of Cobalt 60, Thorium 170, Strontium 90, and combinations thereof. In at least one aspect, the core component outer tube 410 houses a plurality of capsule tubes 420 in a stacked configuration within the outer tube 410 with each capsule tube 420 housing one or more than one target material to be irradiated. In such instances, the plurality of capsule tubes 420 are stacked one on top of the other within the core component outer tube 410. In at least one aspect, the target materials to be irradiate in the stacked configuration within the outer tube 410 are different.

Further to the above, the rodlet 400 further comprises a backfill region 440 defined between the capsule tube 420 and the target material 430. In at least one aspect, the backfill region 440 is an annulus defined between the capsule tube 420 and the target material 430 having a backfill annulus width BA as shown in FIG. 5. In at least one aspect, the backfill annulus width BA is greater than or equal to 0.01 inches and less than or equal to 0.02 inches. In at least one aspect, the backfill region 440 is filled with air and/or helium.

Referring primarily to FIG. 6, the rodlet 400 further comprises a plurality of first flow holes, or first apertures 460, and a plurality of second flow holes, or second apertures 470, positioned above the first apertures 460. The apertures 460, 470 are defined through the core component outer tube 410 at various radial locations around the core component outer tube 410. In at least one aspect, the apertures 460, 470 are positioned at different axial locations along the length of the core component outer tube 410 and/or disposed at different radial locations about the outer tube 410. In at least one aspect, the first apertures 460 and the second apertures 470 are different sizes. In various aspects, the core component outer tube 410 comprises more apertures than the apertures 460, 470 positioned along its length. For instance, another set of apertures may be positioned above the second set of apertures 470 and/or in between the first apertures 460 and the second apertures 470. In at least one aspect, the core component outer tube 410 comprises 14 apertures defined therein. In at least one aspect, the core component outer tube comprises a plurality of apertures numbering greater than or equal to 4 and less than or equal to 20. In any event, the apertures permit reactor coolant to flow into and out of a first annulus 450 during reactor operation.

Referring again to FIG. 5, the rodlet 400 further comprises a first annulus 450 (e.g., inner annulus) defined between the capsule tube 420 and the core component outer tube 410. The first annulus 450 comprises a first annulus width FAW as shown in FIG. 5. Further, a second annulus 500 (e.g., outer annulus) is defined between the core component outer tube 410 and the fuel assembly thimble guide tube 210. The second annulus 500 comprises a second annulus width SAW as shown in FIG. 5. The first annulus 450 and the second annulus 500 permit reactor coolant 600 to flow therethrough. In at least one aspect, reactor coolant flows into the second annulus 500 through a plurality of flow ports 212 defined in the fuel assembly thimble guide tube 210, as shown in FIG. 6. Further, reactor coolant is permitted to flow into and out of the first annulus 450 between the capsule tube 420 and the core component outer tube 410 by way of the plurality of apertures 460, 470 defined in the core component outer tube 410. In at least one aspect, reactor coolant enters the first annulus 450 through the first apertures 460 and exits the first annulus 450 through the second apertures 470. In at least one aspect, the direction of the reactor coolant flow is represented by arrows RCF illustrated in FIG. 6. In any event, permitting reactor coolant to flow on the inside and outside of the core component outer tube 410 equalizes the pressure between the first annulus 450 and the second annulus 500 during operation. Equalizing the pressure between the first annulus 450 and the second annulus 500 avoids potential issues with the outer tube 410 creeping down and contacting the capsule tube 420 during operation, among other things.

Further to the above, the diameter and wall thickness of the capsule tube 420 is sized to resist creep due to the temperature and pressure of the primary reactor coolant and to maintain sufficient clearance between the target material 430 and inner diameter of the capsule tube 420 to allow for ease of target material 430 removal by the radiation source manufacturer after the irradiation period is completed. The capsule tube 420 dimensions are also sized to minimize parasitic neutron absorption by the capsule tube 420 so that radioisotope production is enhanced. In at least one aspect, the target material diameter TD is 0.2 to 0.3 inches and the wall thickness WT of the capsule tube 420 is 0.05 to 0.10 times the target material diameter TD. In at least one aspect, the target material 430 comprises one or more than one slug having a slug diameter of 0.2 to 0.3 inches. In at least one aspect, the wall thickness WT of the capsule tube 420 is 0.05 to 0.10 times the slug diameter of the target material 430.

Further to the above, in at least one aspect, the capsule tube 420 comprises a material with a yield strength greater than or equal to 60 kilopound per square inch (KSI) and less than or equal to 90 KSI. In at least one aspect, the capsule tube 420 comprises a material with a yield strength of greater than or equal to 60 KSI and less than or equal to 70 KSI. In at least one aspect, the capsule comprises one of SS304, Alloy 718, Alloy 625, or combinations thereof. In any event, the capsule tube 420 is configured to keep the target material separate from the reactor coolant for the duration of the irradiation period (e.g., one or more than one PWR operating cycle).

Further to the above, the diameter and wall thickness of the core component outer tube 410 are sized to allow for sufficient coolant flow in the first annulus 450 between the capsule tube 420 and core component outer tube 410 and for sufficient flow in the second annulus 500 between the core component outer tube 410 and the fuel assembly thimble guide tube 210 to preclude boiling during reactor operation. Flow on the inside and outside of the core component outer tube 410 also equalizes pressure avoiding issues with the outer tube 410 creeping down and contacting the capsule tube 420 during operation. In at least one aspect, the first annulus width FAW is 0.65 to 0.85 times greater than the second annulus width SAW (see FIG. 5). Further, in at least one aspect, the apertures 460, 470 comprise a diameter that is two to six times greater than the first annulus width FAW of the first annulus 450.

Further to the above, the core component outer tube 410 is constructed of a low neutron absorbing material so that radioisotope production is enhanced. More specifically, in at least one aspect, the core component outer tube 410 comprises a material with a neutron cross section less than or equal to 0.3 barns. In at least one aspect, the core component outer tube 410 comprises a material with a neutron cross section greater than or equal to 0.1 barns and less than or equal to 0.3 barns. In at least one aspect, the core component outer tube 410 comprises zirconium. In at least one aspect, the core component outer tube 410 comprises zirconium alloy. In at least one aspect, the core component outer tube 410 comprises Zircalloy (ZIRLO). In at least one aspect, the core component outer tube 410 comprises optimized Zircalloy.

Further to the above, the combination of materials for the capsule tube 420 and the core component outer tube 410 and the design features of these individual core component parts have been chosen, at least in part, to preclude hydrogen embrittlement (e.g., hydriding) of either element over the lifetime of the core component assembly. Hydriding of these core component assembly parts would lead to swelling and potential failure during operation and/or during handing after the irradiation period. Further, the above described combination of the high strength capsule tube 420, the core component outer tube 410, and the apertures 460,470 in the outer tube 410 which provide flow into the first annulus 450 have been optimized to prevent creeping of the outer tube 410 onto the capsule tube 420, to prevent creep of the capsule tube 420 onto the target material 430, and to prevent boiling in the regions of the first annulus 450 and the second annulus 500.

Various aspects of the present disclosure include, but are not limited to, the aspects listed in the following numbered clauses.
Clause 1—A rodlet for insertion into a fuel assembly guide tube of a fuel assembly in a pressurized water nuclear reactor. The rodlet comprises a capsule for housing a material to be irradiated, a backfill region disposed between the capsule and the material, and an outer tube comprising a plurality of apertures defined therein. The capsule defines a wall that surrounds the material. The outer tube is to house the capsule. The outer tube defines a first annulus and a second annulus. The first annulus comprises a first width defined between the capsule and the outer tube. The second annulus comprises a second width defined between the outer tube and the fuel assembly guide tube.
Clause 2—The rodlet of clause 1, wherein the material has a first radial diameter, and wherein a radial thickness of the wall of the capsule is 0.05 to 0.10 times the first radial diameter of the material.
Clause 3—The rodlet of clause 1 or 2, wherein the first width is 0.65 to 0.85 times greater than the second width.
Clause 4—The rodlet of clauses 1, 2, or 3, wherein a diameter of each of the plurality of apertures is two to six times the first width.
Clause 5—The rodlet of clauses 1, 2, 3, or 4, wherein the material is 0.2 to 0.3 inches in diameter.
Clause 6—The rodlet of clauses 1, 2, 3, 4, or 5, wherein the capsule comprises a material with a yield strength between 60 kilopound per square inch (KSI) and 90 KSI.
Clause 7—The rodlet of clauses 1, 2, 3, 4, 5, or 6, wherein the outer tube comprises a material with a neutron cross section less than or equal to 0.3 barns.
Clause 8—The rodlet of clauses 1, 2, 3, 4, 5, or 6, wherein the outer tube comprises a material with a neutron cross section greater than or equal to 0.2 barns and less than or equal to 0.3 barns.
Clause 9—The rodlet of clauses 1, 2, 3, 4, 5, 6, 7, or 8, further comprising an end plug at an end of the outer tube and a spacer disposed between the end plug and the capsule to position the capsule at a desired axial location relative to the fuel assembly.
Clause 10—The rodlet of clauses 1, 2, 3, 4, 5, 6, 7, 8, or 9, wherein a top end and a bottom end of the outer tube are sealed.
Clause 11—The rodlet of clauses 1, 2, 3, 4, 5, 6, 7, 8, 9, or 10, wherein the outer tube houses a plurality of capsules in a stacked configuration.
Clause 12—The rodlet of clauses 1, 2, 3, 4, 5, 6, 7, 8, 9, 10, or 11, wherein the apertures allow coolant to flow through the apertures to cool the capsule and equalize pressure on either side of the outer tube.
Clause 13—The rodlet of clauses 1, 2, 3, 4, 5, 6, 7, 8, 9, 10, 11, or 12, wherein the backfill region is filled with air or helium.
Clause 14—The rodlet of clauses 1, 2, 3, 4, 5, 6, 7, 8, 9, 10, 11, 12, or 13, wherein the material is cobalt 59.
Clause 15—The rodlet of clauses 1, 2, 3, 4, 5, 6, 7, 8, 9, 10, 11, 12, 13, or 14, wherein the capsule comprises one of SS304, Alloy 718, or Alloy 625.
Clause 16—The rodlet of clauses 1, 2, 3, 4, 5, 6, 7, 8, 9, 10, 11, 12, 13, 14, or 15 wherein the outer tube comprises zirconium alloy.
Clause 17—The rodlet of clauses 1, 2, 3, 4, 5, 6, 7, 8, 9, 10, 11, 12, 13, 14, 15, or 16, wherein the plurality of apertures is disposed radially about the outer tube and at different vertical elevations.
Clause 18—The rodlet of clauses 1, 2, 3, 4, 5, 6, 7, 8, 9, 10, 11, 12, 13, 14, 15, 16, or 17, wherein the plurality of apertures is greater than or equal to 4 and less than or equal to 20.

All patents, patent applications, publications, or other disclosure material mentioned herein, are hereby incorporated by reference in their entirety as if each individual reference was expressly incorporated by reference respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although claim recitations are presented in a sequence(s), it should be understood that the various operations may be performed in other orders than those which are described, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements, but is not limited to possessing only those one or more elements. Likewise, an element of a system, device, or apparatus that “comprises,” “has,” “includes” or “contains” one or more features possesses those one or more features, but is not limited to possessing only those one or more features.

What is claimed is:

1. A rodlet for insertion into a fuel assembly guide tube of a fuel assembly in a pressurized water nuclear reactor, the rodlet comprising:
a capsule for housing a material to be irradiated, wherein the capsule defines a wall that surrounds the material;
a backfill region disposed between the capsule and the material; and
an outer tube comprising a plurality of apertures defined therein, wherein the outer tube is to house the capsule, and wherein the outer tube defines:
a first annulus comprising a first width defined between the capsule and the outer tube; and
a second annulus comprising a second width defined between the outer tube and the fuel assembly guide tube.

2. The rodlet of claim 1, wherein the material has a first radial diameter, and wherein a radial thickness of the wall of the capsule is 0.05 to 0.10 times the first radial diameter of the material.

3. The rodlet of claim 1, wherein the first width is 0.65 to 0.85 times greater than the second width.

4. The rodlet of claim 1, wherein a diameter of each of the plurality of apertures is two to six times the first width.

5. The rodlet of claim 1, wherein the material is 0.2 to 0.3 inches in diameter.

6. The rodlet of claim 1, wherein the capsule comprises a material with a yield strength of between 60 kilopound per square inch (KSI) and 90 KSI.

7. The rodlet of claim 1, wherein the outer tube comprises a material with a neutron cross section less than or equal to 0.3 barns.

8. The rodlet of claim 1, wherein the outer tube comprises a material with a neutron cross section greater than or equal to 0.2 barns and less than or equal to 0.3 barns.

9. The rodlet of claim 1, further comprising an end plug at an end of the outer tube and a spacer disposed between the end plug and the capsule to position the capsule at a desired axial location relative to the fuel assembly.

10. The rodlet of claim 1, wherein a top end and a bottom end of the outer tube are sealed.

11. The rodlet of claim 1, wherein the outer tube houses a plurality of capsules in a stacked configuration.

12. The rodlet of claim 1, wherein the apertures allow coolant to flow through the apertures to cool the capsule and equalize pressure on either side of the outer tube.

13. The rodlet of claim 1, wherein the backfill region is filled with air or helium.

14. The rodlet of claim 1, wherein the material is cobalt 59.

15. The rodlet of claim 1, wherein the capsule comprises one of SS304, Alloy 718, or Alloy 625.

16. The rodlet of claim 1, wherein the outer tube comprises zirconium alloy.

17. The rodlet of claim 1, wherein the plurality of apertures is disposed radially about the outer tube and at different vertical elevations.

18. The rodlet of claim 1, wherein the plurality of apertures is greater than or equal to 4 and less than or equal to 20.
